(19) United States
(12) Patent Application Publication
(10) Pub. No.: US 2026/0295842 A1
(43) Pub. Date: Oct. 1, 2026

(54) INFORMATION PROCESSING APPARATUS, INFORMATION PROCESSING METHOD, AND RECORDING MEDIUM

(71) Applicant: Panasonic Intellectual Property Management Co., Ltd., Osaka (JP)

(72) Inventor: Duyhinh NGUYEN, Singapore (SG)

(21) Appl. No.: 19/540,218

(22) Filed: Feb. 13, 2026

(30) Foreign Application Priority Data
Mar. 31, 2025 (JP) 2025-059207

(51) Int. Cl. B25J 9/16; B25J 9/00; G06Q 10/0631

(52) U.S. Cl. CPC B25J 9/1689; B25J 9/0084; B25J 9/0093; B25J 9/1661; G06Q 10/0631

(57) ABSTRACT

An information processing apparatus according to an embodiment includes a main server and a centralized management server. The main server generates task information by which a task to be executed by a moving body is identified. The centralized management server generates route information that indicates a travel route for the moving body executing the task identified by the task information. The main server provides, to the centralized management server, cancellation instruction information indicating instruction to cancel the task. The cancellation instruction information is provided after the moving body being currently executing the task based on the task information and the route information receives a cancellation request for cancelling the task from a user.

### CROSS-REFERENCE TO RELATED APPLICATIONS

This application is based upon and claims the benefit of priority from Japanese Patent Application No. 2025-059207, filed on March 31, 2025, the entire contents of which are incorporated herein by reference.

### FIELD

Embodiments described herein relate generally to an information processing apparatus, an information processing method, and a recording medium.

### BACKGROUND

There is a known system that can perform group control of movements of a plurality of moving bodies, such as robots capable of moving in a real space, and assign tasks to the respective moving bodies to cause the moving bodies to execute the tasks (See, for example, Patent literature: JP 2023-81320 A).

However, in such a related art, when a task is canceled in response to a request from a user, there is a concern that a corresponding moving body such as a robot cannot be appropriately operated due to, for example, insufficient cooperation between the moving body and the information processing apparatus that serves to supervise the system.

### SUMMARY

An information processing apparatus according to one aspect of the present disclosure includes a main server and a centralized management server. The main server is configured to generate task information by which a task to be executed by a moving body is identified. The centralized management server is configured to generate route information indicating a travel route for the moving body executing the task identified by the task information. The main server is further configured to provide, to the centralized management server, cancellation instruction information indicating instruction to cancel the task. The cancellation instruction information is provided after the moving body being currently executing the task based on the task information and the route information receives a cancellation request for cancelling the task from a user.

### BRIEF DESCRIPTION OF THE DRAWINGS

FIG. 1 is a diagram illustrating an example of a configuration of an information processing system according to a first embodiment of the present disclosure;

FIG. 2 is a diagram illustrating an example of task management information according to the first embodiment;

FIG. 3 is a diagram illustrating an example of robot management information according to the first embodiment;

FIG. 4 is a diagram illustrating an example of functions of a processor according to the first embodiment;

FIG. 5 is a sequence diagram illustrating an example of an operation procedure of the information processing system according to the first embodiment;

FIG. 6 is a diagram illustrating a task of a robot in the first embodiment;

FIG. 7 is a diagram illustrating a task of the robot in the first embodiment;

FIG. 8 is a diagram illustrating an example of functions of the robot according to the first embodiment;

FIG. 9 is a diagram illustrating an example of a procedure of processing of the information processing system according to the first embodiment; and

FIG. 10 is a diagram illustrating an example of a procedure of processing of an information processing system according to a second embodiment of the present disclosure.

### DETAILED DESCRIPTION

Hereinafter, an information processing apparatus, an information processing method, and a recording medium according to embodiments of the present disclosure will be described in detail with reference to the accompanying drawings.

### First Embodiment

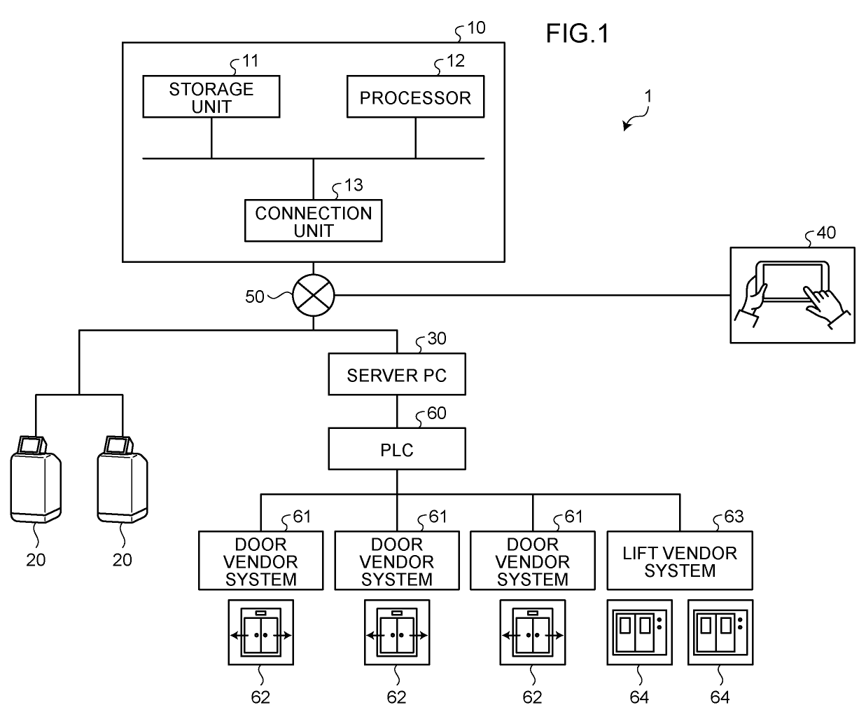

FIG. 1 is a diagram illustrating an example of a configuration of an information processing system 1 according to the present embodiment.

The information processing system 1 of the present embodiment is a system for operating a plurality of robots (an example of "moving bodies") each being capable of autonomously traveling in a facility such as a hospital in response to a request from a user.

As illustrated in FIG. 1, the information processing system 1 includes an information processing apparatus 10, a plurality of robots 20, a server personal computer (PC) 30, and a terminal 40 used by the user.

The information processing apparatus 10, the plurality of robots 20, the server PC, and the terminal 40 are connected to one another via a network 50 such as the Internet. Note that, in the example of FIG. 1, two robots 20 are illustrated, but the number of robots 20 included in the information processing system 1 is not limited thereto and can be optionally changed with design conditions and the like.

Also, as illustrated in FIG. 1, the server PC 30 is connected to a programmable logic controller (PLC) 60. The PLC 60 is connected to a door 62 in the facility via a door vendor system 61 and is connected to a lift 64 (elevator) in a facility via a lift vendor system 63. In the example of FIG. 1, three of the doors 62 and two of the lifts 64 are illustrated, but the number of doors 62 and the number of lifts 64 are not limited thereto and can be optionally changed with design conditions and the like. The PLC 60 controls operations of the door 62 and the lift 64 according to a command from the server PC 30.

The terminal 40 used by the user may be, for example, a portable device such as a tablet or a smartphone, or a PC such as a desktop PC.

The information processing apparatus 10 performs control to operate the robots 20 in response to a request from the user. For example, the information processing apparatus 10 assigns a task requested by the user to any of the robots 20 to cause the robot to execute the task. In the present embodiment, there are two states of the robot 20: “Free” indicating a state where a task can be assigned (or a state where the robot 20 is not in use); and "Reserved" indicating a state where a task cannot be assigned (or a state where the robot 20 is in use). The information processing apparatus 10 assigns a task requested by the user to any of the “Free” robots 20 and causes this robot to execute the requested task.

As illustrated in FIG. 1, the information processing apparatus 10 includes a storage unit 11, a processor 12, and a connection unit 13. These elements can be connected to each other via, for example, an internal bus. The connection unit 13 is an interface for connecting to the network 50. Note that the hardware configuration of the information processing apparatus 10 is not limited to the example of FIG. 1, and may further include hardware elements other than the elements illustrated in FIG. 1.

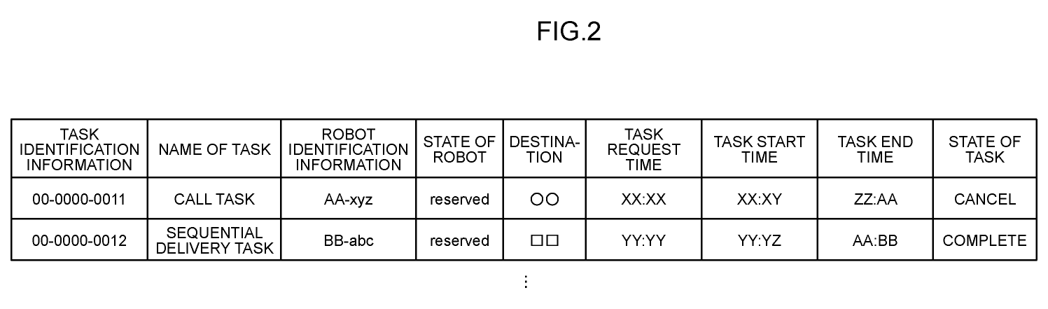

The storage unit 11 stores various types of information such as a computer program executed by the processor 12, task management information for managing a task, and robot management information for managing the robot 20. FIG. 2 is a diagram illustrating an example of the task management information. In the example of FIG. 2, the task management information is information in which the following types of information are associated with each other: task identification information for identifying a task, information indicating a name (type) of the task, robot identification information for identifying the robot 20 that executes the task, information indicating a state of the robot 20, information indicating a destination of the robot 20, information indicating time when the task is requested, information indicating time when the task is started, information indicating time when the task is completed, and information indicating a state of the task.

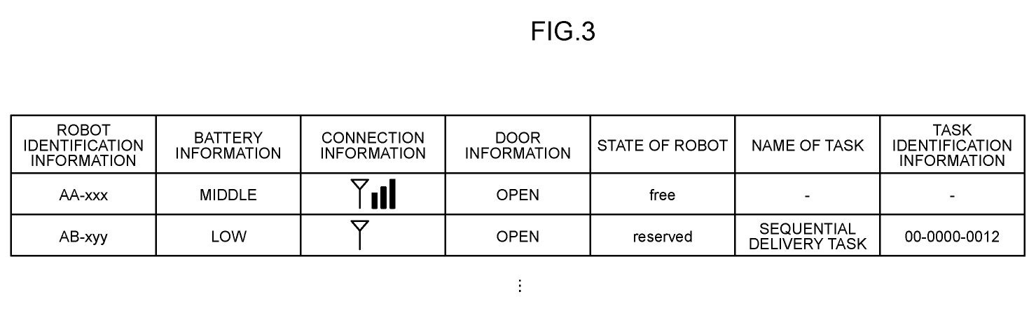

FIG. 3 is a diagram illustrating an example of the robot management information. In the example of FIG. 3, the robot management information is information in which the following types of information are associated with each other: the robot identification information, battery information indicating the level of a remaining battery amount of the robot 20, connection information indicating a connection state (communication state) of the network 50, door information indicating an open/close state of a door of a storing chamber in which the robot 20 is stored, the information indicating the state of the robot, the information indicating the name of the task, and the task identification information.

Referring back to FIG. 1, the description is continued. The processor 12 is a device that comprehensively controls the operation of the information processing apparatus 10 and can implement various functions by executing a computer program stored in the storage unit 11. The program may be provided by being recorded, as a file in a format installable on and executable by a computer, on a non-transitory computer-readable recording medium such as a CD-ROM, a flexible disk (FD), a CD-R, a digital versatile disc (DVD), etc.

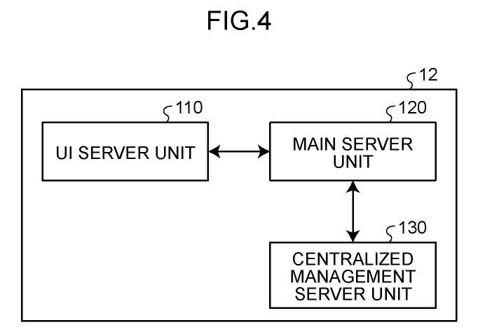

FIG. 4 is a diagram illustrating an example of functions of the processor 12. As illustrated in FIG. 4, the processor 12 includes an UI server unit 110, a main server unit 120 (an example of the main sever), and a centralized management server unit 130 (an example of the centralized management sever). These functions can be implemented by the processor 12 executing a program stored in the storage unit 11. Note that, in the example of FIG. 4, only the functions necessary for describing the main part of the present embodiment are illustrated, but the functions of the processor 12 are not limited thereto. Moreover, some of or all the functions of each of the server units described above may be implemented by hardware circuitry.

The UI server unit 110 analyzes operation information that is indicative of an operation received from a user and is transmitted by the terminal 40. The UI server unit 110 then provides information indicating an analysis result to the main server unit 120.

The main server unit 120 assigns the task requested by the user to any one of the robots 20 to cause the robot to execute the task. When, for example, the user performs an operation for requesting the terminal 40 to execute a certain task, the terminal 40 transmits operation information indicating the operation received from the user to the information processing apparatus 10 via the network 50. In the information processing apparatus 10 that has received the operation information from the terminal 40, the main server unit 120 can identify the requested task based on the information indicating the analysis result of the operation information by the UI server unit 110. Then, the main server unit 120 assigns the identified task to any one of the “Free” robots 20 to cause the robot to execute the task. The main server unit 120 assigns the task to any one robot 20 among the robots 20 that is “Free” and is not logged in. The expression of "being not logged in" means that the robot 20 is in a state where the user is not authenticated, that is, a state where the robot 20 verifies whether the user has authority to use the robot 20 and approves that the user has the authority to use the robot 20.

In one example, the user performs an operation for obtaining approval that the user has authority to use the robot 20 (login operation) by using a face screen of the robot 20 displayed on a display (display unit) on the face of the robot 20. When the robot 20 approves that the user has the authority to use the robot 20 (that is, when the user is authenticated), the robot 20 can receive an operation from an authenticated user. An authentication method by the robot 20 will be described later. When the logged-in user inputs an operation for requesting execution of a task to the face screen of the robot 20, the robot 20 transmits information indicating the requested task, which is identified from the operation of the user, to the information processing apparatus 10 via the network 50. In the information processing apparatus 10, the main server unit 120 identifies a task requested by the user based on the information received from the robot 20, and assigns the identified task to the robot that is the transmission source of the information. Then, the main server unit 120 causes the robot 20 to execute the task.

After assigning the task requested by the user to the robot 20, the main server unit 120 generates task information that is information by which the task to be executed by the robot 20 can be identified. Examples of the task information include information for identifying a task (task identification information), information indicating a type (name) of the task, and information indicating a destination of the robot 20. The main server unit 120 provides the generated task information to the centralized management server unit 130 and transmits the same to the robot 20 that executes this task.

The centralized management server unit 130 receives the task information from the main server unit 120 and generates route information indicating a travel route for the robot 20 that executes the task identified by the received task information. The function of the centralized management server unit 130 may be implemented by, for example, a robotics middleware framework (RMF). In this case, the RMF can be adopted as an example of a computer program for providing the function of the centralized management server unit 130. The centralized management server unit 130 determines an optimal travel route of the robot 20 that executes the task while organizing the traffic of each robot based on the travel situation of each robot 20 and transmits route information indicating the determined travel route to the robot 20.

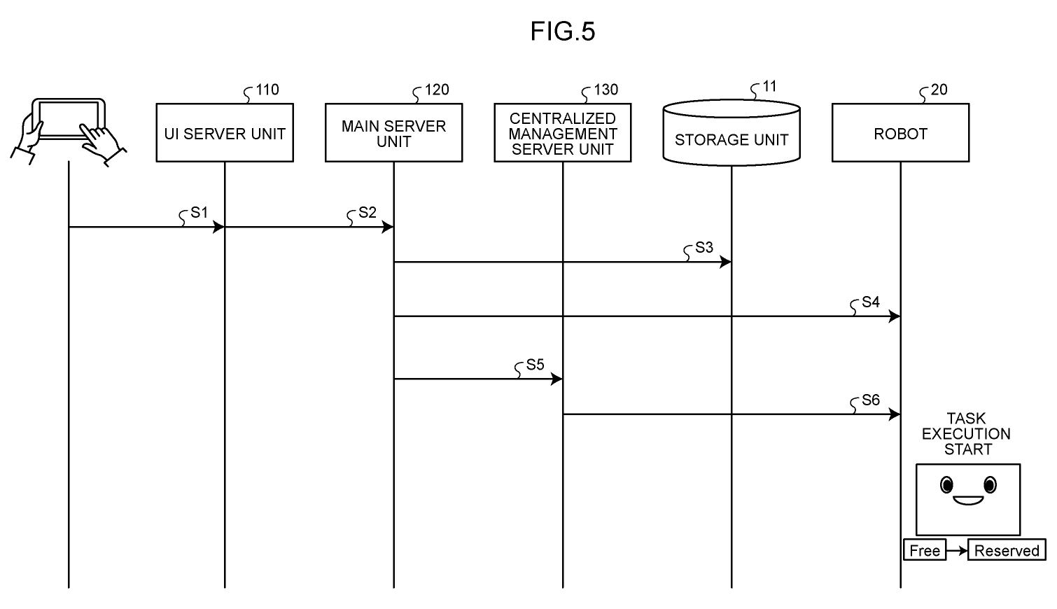

FIG. 5 is a sequence diagram illustrating an example of a procedure of information in a case where the robot 20 is caused to execute a task in response to a request from the user. As illustrated in FIG. 5, when the user performs an operation of requesting the terminal 40 to execute a task, the terminal 40 transmits operation information indicating the operation received from the user to the information processing apparatus 10 (step S1).

The UI server unit 110 provides, to the main server unit 120, information indicating a result of analyzing the operation information received from the terminal 40 (for example, the type of the requested task) (step S2). The main server unit 120 can identify the task requested from the user based on the information received from the UI server unit 110. The main server unit 120 determines the robot 20 that executes the identified task and generates the task information described above. Then, the main server unit 120 inputs the generated task information to the storage unit 11 to store the task information (step S3). In addition, the main server unit 120 transmits the generated task information to the robot 20 that executes the task (step S4) and provides the generated task information to the centralized management server unit 130 (step S5). The centralized management server unit 130 may be notified of the robot identification information for identifying the robot 20 that executes the task, separately from reception of the task information. In addition, for example, the robot identification information may be included in the task information.

The centralized management server unit 130 that has received the task information determines the optimal travel route for the robot 20 that executes the task based on the travel situation of the other robot 20 and generates the route information indicating the determined travel route. Then, the centralized management server unit 130 transmits the generated route information to the robot 20 (step S6).

The robot 20 executes a task based on the task information received from the main server unit 120 and the route information received from the centralized management server unit 130. Then, the robot 20 updates the state of itself from “Free” to "Reserved" and performs management.

Next, the robot 20 will be described. In the present embodiment, examples of the task executed by the robot 20 include a call task, a delivery task, and a sequential delivery task.

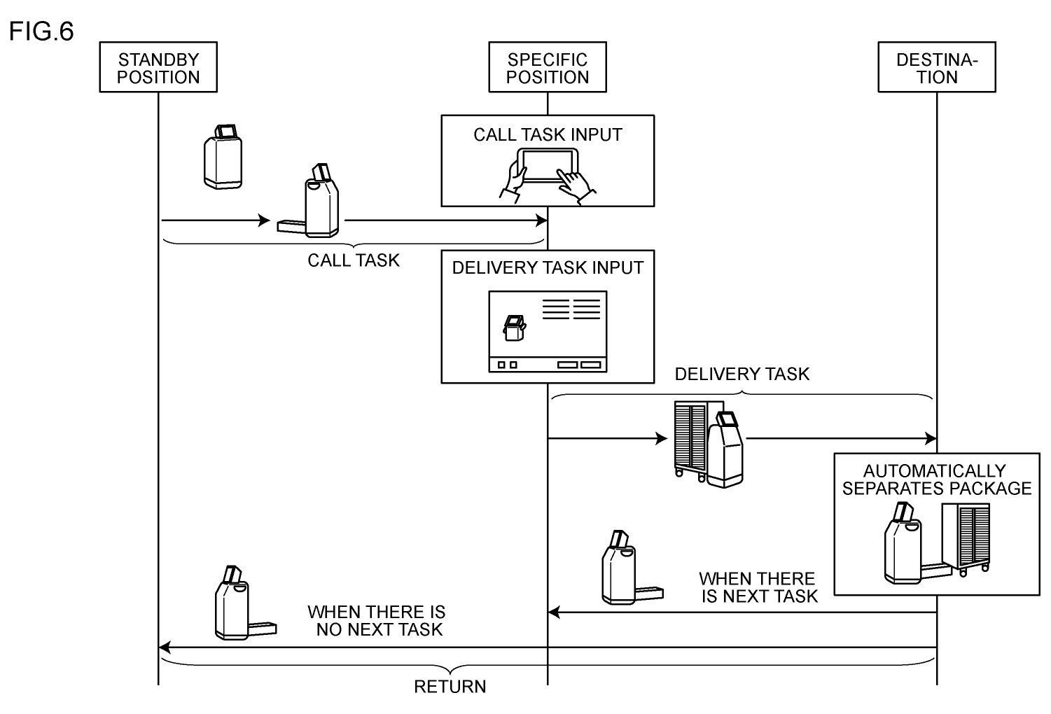

The call task refers to a work of calling the robot 20 from a standby position to a specific position. As illustrated in FIG. 6, when the user performs an operation of requesting the terminal 40 to execute the call task (for example, an operation of touching a predetermined button arranged on the screen), the robot 20 starts to execute the call task through the procedure of information as described in FIG. 5 and moves from the standby position to the specific position. In one example, a charger for charging the robot 20 is installed at the standby position.

The delivery task refers to a work that the robot 20 delivers a package from a current location to a destination. As illustrated in FIG. 6, when the logged-in user performs an operation of selecting a destination to be the delivery destination of the package and requesting the execution of the delivery task on the face screen of the robot 20, the robot 20 transmits information indicating the delivery task identified from the received operation to the main server unit 120. Thereafter, the robot 20 starts the execution of the delivery task through the procedure of information after step S3 in FIG. 5 and moves from the current location to the destination. Upon arriving at the destination, the robot 20 automatically separates the package and starts execution of the next task when the next task has already been assigned. Note that a case where the robot 20 automatically separates the package is described as an example, but the present disclosure is not limited thereto. For example, the robot 20 may separate the package in response to pressing a "Return" button by the user. Meanwhile, when the next task is not assigned, the robot 20 returns to the standby position and stands by.

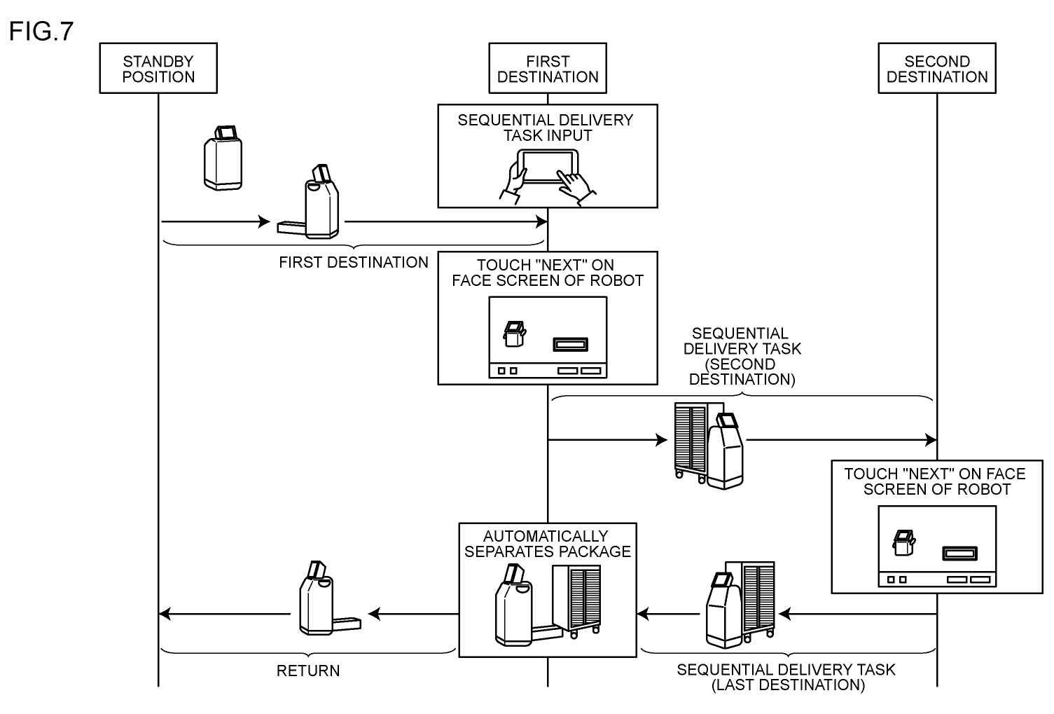

The sequential delivery task refers to a work that the robot 20 sequentially delivers the package to a plurality of destinations (delivery destinations). As illustrated in FIG. 7, when the user performs an operation of requesting the terminal 40 to execute the sequential delivery task, the robot 20 starts to execute the sequential delivery task through the procedure of information as described in FIG. 5 and first moves from the standby position to a first destination. In the example of FIG. 7, it is assumed that, after the robot 20 arrives at the first destination, the user who has logged in to the robot 20 performs an operation of touching a button indicating "Next" arranged on the face screen of the robot 20. The robot 20 moves to a second destination in response to the touch operation. The operation of touching the button indicating "Next" can be considered as an operation for requesting delivery of package to the next destination.

In the example of FIG. 7, a scene in which, after the robot 20 arrives at the second destination, the user who has logged in to the robot 20 performs an operation of touching a button indicating "Next" arranged on the face screen of the robot 20 is assumed, and the robot 20 moves to a third destination (a last destination in this example) in response to this operation. Upon arriving at the destination, the robot 20 automatically separates the package and starts execution of the next task when the next task has already been assigned. Meanwhile, when the next task is not assigned, the robot 20 returns to the standby position and stands by.

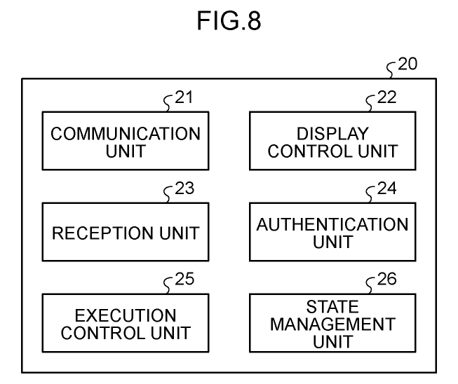

FIG. 8 is a diagram illustrating an example of functions of the robot 20. As illustrated in FIG. 8, the robot 20 includes a communication unit 21, a display control unit 22, a reception unit 23, an authentication unit 24, a task execution control unit 25, and a state management unit 26. Note that the functions of the robot 20 are not limited to the functions illustrated in FIG. 8.

In the present embodiment, the robot 20 includes at least a processor, memories, and a display unit (for example, a display provided on the face of the robot 20) as hardware elements and the functions of the above-described units can be implemented by the processor executing a program stored in the memory. However, the present disclosure is not limited thereto, and some of or all the functions of the units described above may be implemented by dedicated hardware circuitry (semiconductor integrated circuit or the like).

The communication unit 21 communicates with the information processing apparatus 10 via the network 50 and performs transmission and reception of the information. The display control unit 22 performs control to display various types of information including the face screen on the display unit. The reception unit 23 receives an input according to a user's operation. For example, the reception unit 23 can receive an input corresponding to a touch operation on the face screen.

The authentication unit 24 authenticates the user. Various known methods can be used for authentication. For example, when the user calls an authentication screen to be displayed on the face display unit of the robot 20 and inputs information for identifying the user (for example, a password) through the authentication screen, the authentication unit 24 verifies the input information with information of an authentication source registered in advance. If those pieces of information match with each other, it is approved that the user who has input the information has authority to use the robot 20. That is, the user is authenticated.

The task execution control unit 25 controls execution of a task by the robot 20 based on the task information received from the main server unit 120 and the route information received from the centralized management server unit 130. For example, the task execution control unit 25 can perform control to cause the robot 20 to travel along the travel route indicated by the route information or can perform control to separate the package after arriving at the destination.

The state management unit 26 manages the state of the robot 20. The memory of the robot 20 may store information corresponding to the own device out of the robot management information illustrated in FIG. 3. The state management unit 26 manages the information. When the task of the robot 20 is completed, the state management unit 26 updates the state of the own device from "Reserved" to “Free”. Then, the main server unit 120 is notified of information indicating that the task has been completed and information indicating that the state of the own device has changed from "Reserved" to “Free”. The main server unit 120 that has received this notification can update the information on the information processing apparatus 10 side.

The above is the configuration of the information processing system 1 as a premise of the present disclosure. Next, a method for causing the robot 20 to execute the same task after the robot 20 cancels the task being executed will be described.

After the robot 20 that is executing the task receives a cancellation request for requesting cancellation of the task, the main server unit 120 provides, to the centralized management server unit 130, cancellation instruction information for instructing cancellation of the task that is being executed. The logged-in user can input the cancellation request by, for example, touching a predetermined button (such as a button indicating "Cancel") disposed on the face screen of the robot 20. In the present embodiment, the robot 20 stops traveling upon receiving a cancellation request from the user, but does not notify the information processing apparatus 10 that the task being executed has been canceled. Therefore, the information processing apparatus 10 side recognizes that the robot 20 is continuously executing the task.

Thereafter, upon receiving retry request information indicating that a retry request for requesting execution of the same task is received from the robot 20, the main server unit 120 provides, to the centralized management server unit 130, cancellation instruction information for instructing cancellation of the task being executed. The logged-in user can input the retry request by, for example, touching a predetermined button (such as a button indicating "Retry") on the face screen of the robot 20. Upon receiving the retry request, the robot 20 transmits the retry request information to the information processing apparatus 10.

Upon receiving the cancellation instruction information described above from the main server unit 120, the centralized management server unit 130 recognizes that the task being executed has been canceled and enters a state capable of receiving new task information. After providing the cancellation instruction information to the centralized management server unit 130, the main server unit 120 refers to a transmission history of the task information for the robot 20 and provides, to the centralized management server unit 130 and the robot 20, the latest task information among the task information already transmitted to the robot 20 before receiving the retry request information.

The centralized management server unit 130 generates route information based on the task information received from the main server unit 120 and transmits the generated route information to the robot 20. The robot 20 executes the task again based on the task information received from the main server unit 120 and the route information received from the centralized management server unit 130.

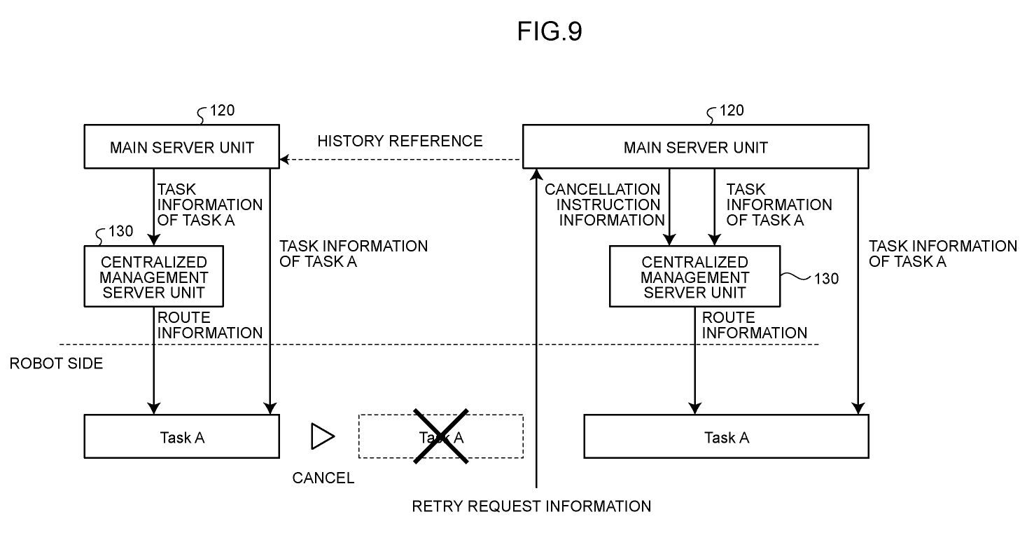

FIG. 9 is a schematic diagram illustrating a procedure of processing when the robot 20 executing a task A receives a retry request after receiving a cancellation request from the user. Upon receiving the cancellation request from the logged-in user, the robot 20 stops traveling (that is, cancels the task A). Thereafter, upon receiving the retry request from the user, the robot 20 transmits the retry request information to the information processing apparatus 10.

By receiving the retry request information from the robot 20, the main server unit 120 recognizes that the execution of the task A has been canceled and retry is requested. The main server unit 120 provides the cancellation instruction information to the centralized management server unit 130. The centralized management server unit 130 that has received the cancellation instruction information recognizes that the task A has been canceled and enters a state capable of receiving new task information.

After providing the cancellation instruction information to the centralized management server unit 130, the main server unit 120 refers to the history of the task information that has been transmitted to the robot 20 and transmits the task information of the task A that is the latest task to each of the centralized management server unit 130 and the robot 20. The centralized management server unit 130 regenerates the route information based on the task information of the task A received from the main server unit 120 and transmits the generated route information to the robot 20. The robot 20 executes the task again based on the task information of the task A received from the main server unit 120 and the route information received from the centralized management server unit 130.

As described above, when the retry request information is received from the robot 20, the main server unit 120 of the present embodiment recognizes that the task being currently executed has been canceled and retry of the same task is requested. The main server unit 120 provides the cancellation instruction information instructing cancellation of the task to the centralized management server unit 130. The main server unit 120 then provides task information of the same task to the centralized management server unit 130 and transmit this task information to the robot 20. The centralized management server unit 130 that has received the cancellation instruction information recognizes that the task being executed has been canceled and enters a state where new task information can be received. Therefore, thereafter, route information can be regenerated based on the task information received from the main server unit 120, and the generated route information can be transmitted to the robot 20. Then, the robot 20 can retry the canceled task based on the task information received from the main server unit 120 and the route information received from the centralized management server unit 130.

According to the present embodiment, it is possible to prevent the robot 20 from being unable to retry the task, which may be caused by a situation that the centralized management server unit 130 cannot recognize that the task currently executed has been canceled and does not receive the task information of the task to be retried.

### Modification of First Embodiment

In the embodiment described above, when the cancellation request is received from the user, the robot 20 does not notify the information processing apparatus 10 that the cancellation request has been received. However, the robot 20 may transmit, to the information processing apparatus 10, cancellation request information indicating that the cancellation request has been received. Then, the main server unit 120 may provide, to the centralized management server unit 130, cancellation instruction information for cancelling the task currently executed, thereby causing the centralized management server unit 130 to recognize that the task has been canceled.

In short, the main server unit 120 may provide the cancellation instruction information to the centralized management server unit 130 so as to cancel the currently-executed task after the robot 20 receives the cancellation request. The timing of providing the cancellation instruction information to the centralized management server unit 130 "after the robot 20 receives the cancellation request" may be the timing at which the robot 20 transmits the retry request information to the information processing apparatus 10 as in the above-described first embodiment, or may be the timing at which the robot 20 transmits the cancellation request information to the information processing apparatus 10 as in the present modification.

### Second Embodiment

Next, a second embodiment will be described. Description of parts common to those of the first embodiment described above is omitted as appropriate. In the first embodiment, the robot 20 receives the cancellation request from the user, but in the present embodiment, the terminal 40 receives the cancellation request from the user, and the subsequent processing is also different. Hereinafter, specific contents are described. Note that the underlying system configuration is the same as that of the first embodiment described above.

Upon receiving (via the UI server unit 110) cancellation request information indicating that the robot 20 has received a cancellation request for requesting cancellation of the task currently executed from the terminal 40 used by the user, the main server unit 120 provides the cancellation instruction information instructing cancellation of the task to the centralized management server unit 130 and transmits the same information to the robot 20.

Similarly to the first embodiment described above, upon receiving the cancellation instruction information from the main server unit 120, the centralized management server unit 130 recognizes that the task being executed has been canceled and enters a state capable of receiving new task information.

The robot 20 stops traveling upon receiving the cancellation instruction information from the main server unit 120. Then, the robot 20 notifies the main server unit 120 of a change from "Reserved" indicating a state where the task cannot be assigned (an example of a first state) to "Free" indicating a state where the task can be assigned (an example of a second state). Thereafter, the main server unit 120 determines the robot 20 to which the new task is to be assigned from the "Free" robots 20.

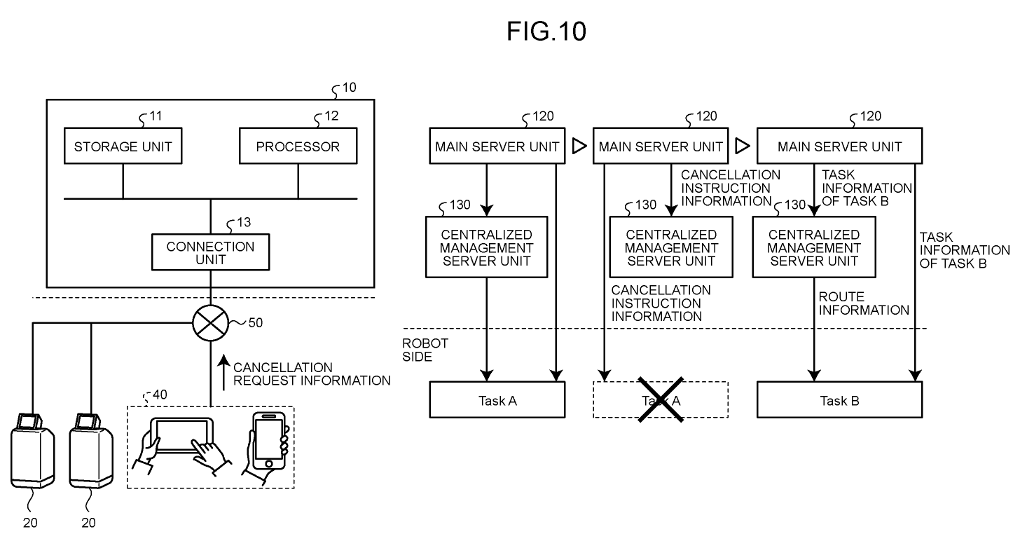

FIG. 10 is a schematic diagram illustrating a procedure of processing when the terminal 40 receives a cancellation request for requesting cancellation of the task A being executed by the robot 20. When the robot 20 is executing the task A based on the task information of the task A received from the main server unit 120 and the route information received from the centralized management server unit 130, and the cancellation request is received from the user, the terminal 40 transmits the cancellation request information to the information processing apparatus 10. The user can input a cancellation request by, for example, touching a predetermined button (such as a button indicating "Cancel") in a screen displayed on the display unit of the terminal 40.

Upon receiving the cancellation request information from the terminal 40, the main server unit 120 recognizes that cancellation of the task A has been requested. The main server unit 120 provides and transmits the cancellation instruction information to the centralized management server unit 130 and the robot 20, respectively. The centralized management server unit 130 that has received the cancellation instruction information recognizes that the task A has been canceled and enters a state capable of receiving new task information.

The robot 20 that has received the cancellation instruction information from the main server unit 120 stops traveling. The robot 20 updates the state of the own device from "Reserved" to “Free” and notifies the main server unit 120 of the update. The main server unit 120 that has received the notification performs update of information on the information processing apparatus 10 side. The main server unit 120 assigns a task based on the status of an unexecuted task or the like, but in the example of FIG. 10, it is assumed that a new task B is assigned to the robot 20 from which the task A has been canceled. In this case, the main server unit 120 provides and transmits task information of the task B to the centralized management server unit 130 and the robot 20, respectively. The centralized management server unit 130 generates the route information based on the task information of the task B received from the main server unit 120 and transmits the generated route information to the robot 20. The robot 20 executes the task B based on the task information of the task B received from the main server unit 120 and the route information received from the centralized management server unit 130.

As described above, upon receiving the cancellation request information from the terminal 40, the main server unit 120 of the present embodiment provides and transmits the cancellation instruction information to the centralized management server unit 130 and the robot 20, respectively. As a result, it is possible to cause the centralized management server unit 130 to recognize that the task being executed has been canceled and enter a state where new task information can be received and to cause the robot 20 to stop traveling.

The centralized management server unit 130 transmits the route information to the robot 20 but does not include means for stopping the robot 20 executing the task. Therefore, in the present embodiment, by transmitting the cancellation instruction information from the main server unit 120 to the robot 20, it is possible to reliably stop the robot 20 that is executing the task.

### Modification of Second Embodiment

The delivery task indicating the work of the robot 20 delivering the package from the predetermined location (for example, the current location) to the destination may be set so as to be unable to be canceled from the terminal 40. In one example, upon receiving the cancellation request information for requesting cancellation of the delivery task from the terminal 40, the main server unit 120 does not provide and transmit the cancellation instruction information to the centralized management server unit 130 and the robot 20, respectively. In one example, the terminal 40 does not receive (that is, the terminal is set to be unable to receive) a cancellation request for cancellation of the delivery task from the user. In one example, the terminal 40 allows reception of the cancellation request whereas transmits no cancellation request information to the information processing apparatus 10. In the delivery task, the user basically inputs an instruction to the UI (for example, the face screen) of the robot 20 to move the robot 20, so that it is likely that some package is contained in a storage (storage for storing package) of the robot 20. Therefore, if the delivery task is canceled and the robot 20 moves to another place in a state where the package is in the storage, there is a concern that the package is lost. Therefore, in the present modification, it is possible to prevent the loss of the package by setting the delivery task so as to be unable to be canceled from the terminal 40.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

### Supplementary Note

Hereinafter, preferred aspects of the present disclosure will be supplementarily described.

### Appendix 1

An information processing apparatus, comprising:

a main server configured to generate task information by which a task to be executed by a moving body is identified; and

a centralized management server configured to generate route information indicating a travel route for the moving body executing the task identified by the task information,

wherein the main server is further configured to provide, to the centralized management server, cancellation instruction information indicating instruction to cancel the task, the cancellation instruction information being provided after the moving body being currently executing the task based on the task information and the route information receives a cancellation request for cancelling the task from a user.

### Appendix 2

The information processing apparatus according to the appendix 1, wherein the main server is further configured to provide the cancellation instruction information to the centralized management server when retry request information is received from the moving body, the retry request information indicating that a retry request for executing the same task has been received.

### Appendix 3

The information processing apparatus according to the appendix 2, wherein the main server is further configured to, when the retry request information is received from the moving body, provide latest task information to the centralized management server and transmit the latest task information to the moving body by referring to a transmission history of the task information to the moving body, the latest task information being a latest one of pieces of the task information having been transmitted to the moving body.

### Appendix 4

The information processing apparatus according to the appendix 1, wherein the task information includes information for identifying the task, information indicating a type of the task, and information indicating a destination of the moving body.

### Appendix 5

An information processing apparatus, comprising:

a main server configured to generate task information by which a task to be executed by a moving body is identified; and

a centralized management server configured to generate route information indicating a travel route for the moving body executing the task identified by the task information,

wherein the main server is further configured to, when cancellation request information is received from a terminal used by a user, provide cancellation instruction information to the centralized management server and transmit the cancellation instruction information to the moving body, the cancellation request information indicating that a cancellation request for cancelling the task being currently executed by the moving body has been received, the cancellation instruction information indicating instruction to cancel the task.

### Appendix 6

The information processing apparatus according to the appendix 5, wherein the main server is further configured to

receive notification from one or more moving bodies having been stopped in response to receiving the cancellation instruction information, the notification indicating that the moving body changes from a first state where the task is unable to be assigned to a second state where the task is able to be assigned, and

determine a moving body to which a new task is assigned from among the one or more moving bodies being in the second state.

### Appendix 7

The information processing apparatus according to the appendix 5, wherein

the task includes a delivery task indicating a work of delivering a package from a predetermined location to a destination, and

the delivery task is set to be unable to be canceled by the terminal.

### Appendix 8

An information processing method implemented by an information processing apparatus including a main server and a centralized management server, the method comprising:

generating, by the main server, task information by which a task to be executed by a moving body is identified;

generating, by the centralized management server, route information indicating a travel route for the moving body executing the task identified by the task information; and

providing, from the main server to the centralized management server, cancellation instruction information indicating instruction to cancel the task, the cancellation instruction information being provided after the moving body being currently executing the task based on the task information and the route information receives a cancellation request for cancelling the task from a user.

### Appendix 9

A non-transitory computer-readable recording medium on which programmed instructions are recorded, the programmed instructions causing a computer to implement the information processing method according to the appendix 8.

### Appendix 10

An information processing method implemented by an information processing apparatus including a main server and a centralized management server, the method comprising:

generating, by the main server, task information by which a task to be executed by a moving body is identified;

generating, by the centralized management server, route information indicating a travel route for the moving body executing the task identified by the task information; and,

when cancellation request information is received from a terminal used by a user, providing cancellation instruction information from the main server to the centralized management server and transmitting the cancellation instruction information from the main server to the moving body, the cancellation request information indicating that a cancellation request for cancelling the task being currently executed by

the moving body has been received, the cancellation instruction information indicating instruction to cancel the task.

### Appendix 11

A non-transitory computer-readable recording medium on which programmed instructions are recorded, the programmed instructions causing a computer to implement the information processing method according to the appendix 10.

According to the present disclosure, even when a task is canceled in response to a request from a user, a moving body can be appropriately operated.

What is claimed is:

1. An information processing apparatus, comprising:
a main server configured to generate task information by which a task to be executed by a moving body is identified; and
a centralized management server configured to generate route information indicating a travel route for the moving body executing the task identified by the task information,
wherein the main server is further configured to provide, to the centralized management server, cancellation instruction information indicating instruction to cancel the task, the cancellation instruction information being provided after the moving body being currently executing the task based on the task information and the route information receives a cancellation request for cancelling the task from a user.

2. The information processing apparatus according to claim 1, wherein the main server is further configured to provide the cancellation instruction information to the centralized management server when retry request information is received from the moving body, the retry request information indicating that a retry request for executing the same task has been received.

3. The information processing apparatus according to claim 2, wherein the main server is further configured to, when the retry request information is received from the moving body, provide latest task information to the centralized management server and transmit the latest task information to the moving body by referring to a transmission history of the task information to the moving body, the latest task information being a latest one of pieces of the task information having been transmitted to the moving body.

4. The information processing apparatus according to claim 1, wherein the task information includes information for identifying the task, information indicating a type of the task, and information indicating a destination of the moving body.

5. An information processing apparatus, comprising:
a main server configured to generate task information by which a task to be executed by a moving body is identified; and
a centralized management server configured to generate route information indicating a travel route for the moving body executing the task identified by the task information,
wherein the main server is further configured to, when cancellation request information is received from a terminal used by a user, provide cancellation instruction information to the centralized management server and transmit the cancellation instruction information to the moving body, the cancellation request information indicating that a cancellation request for cancelling the task being currently executed by the moving body has been received, the cancellation instruction information indicating instruction to cancel the task.

6. The information processing apparatus according to claim 5, wherein the main server is further configured to
receive notification from one or more moving bodies having been stopped in response to receiving the cancellation instruction information, the notification indicating that the moving body changes from a first state where the task is unable to be assigned to a second state where the task is able to be assigned, and
determine a moving body to which a new task is assigned from among the one or more moving bodies being in the second state.

7. The information processing apparatus according to claim 5, wherein
the task includes a delivery task indicating a work of delivering a package from a predetermined location to a destination, and
the delivery task is set to be unable to be canceled by the terminal.

8. An information processing method implemented by an information processing apparatus including a main server and a centralized management server, the method comprising:
generating, by the main server, task information by which a task to be executed by a moving body is identified;
generating, by the centralized management server, route information indicating a travel route for the moving body executing the task identified by the task information; and
providing, from the main server to the centralized management server, cancellation instruction information indicating instruction to cancel the task, the cancellation instruction information being provided after the moving body being currently executing the task based on the task information and the route information receives a cancellation request for cancelling the task from a user.

9. A non-transitory computer-readable recording medium on which programmed instructions are recorded, the programmed instructions causing a computer to implement the information processing method according to claim 8.

10. An information processing method implemented by an information processing apparatus including a main server and a centralized management server, the method comprising:
generating, by the main server, task information by which a task to be executed by a moving body is identified;
generating, by the centralized management server, route information indicating a travel route for the moving body executing the task identified by the task information; and,
when cancellation request information is received from a terminal used by a user, providing cancellation instruction information from the main server to the centralized management server and transmitting the cancellation instruction information from the main server to the moving body, the cancellation request information indicating that a cancellation request for cancelling the task being currently executed by the moving body has been received, the cancellation instruction information indicating instruction to cancel the task.

11. A non-transitory computer-readable recording medium on which programmed instructions are recorded, the programmed instructions causing a computer to implement the information processing method according to claim 10.
